(19) United States
(12) Patent Application Publication
(10) Pub. No.: US 2024/0388974 A1
(43) Pub. Date: Nov. 21, 2024

(54) APPARATUS AND METHODS FOR DATA SCHEDULING

(71) Applicant: MEDIATEK INC., Hsinchu City (TW)

(72) Inventors: Chi-Hsuan HSIEH, Hsinchu City (TW); Chia-Chun HSU, Hsinchu City (TW); Hsuan-Li LIN, Hsinchu City (TW); Din-Hwa HUANG, Hsinchu City (TW)

(21) Appl. No.: 18/692,931

(22) PCT Filed: Oct. 19, 2022
(86) PCT No.: PCT/CN2022/126225

§ 371 Date: Mar. 18, 2024

Related U.S. Application Data
(60) Provisional application No. 63/257,166, filed on Oct. 19, 2021.
(60) Provisional application No. 63/271,254, filed on Oct. 25, 2021.

(51) Int. Cl. H04W 36/00; H04W 72/0446; H04W 72/1268; H04W 72/1273

(52) U.S. Cl. CPC H04W 36/0058; H04W 36/0088; H04W 72/0446; H04W 72/1268; H04W 72/1273

(57) ABSTRACT

Apparatus and method for data scheduling are proposed. The user equipment (UE) may provide an indication or a measurement report to the network node. The network node may determine whether to schedule data within at least one time duration which is configured to the UE for measurement based on the indication or the measurement report. Therefore, for some real-time application (e.g., virtual reality (VR) or augmented reality (AR)), the service will not be interrupted.

### CROSS REFERENCE TO RELATED APPLICATIONS

This application claims priority under 35 U.S.C. § 119 from U.S. Provisional Application No. 63/257,166, entitled “Additional NW scheduling availability for SMTC window or measurement gap and potential UE assistance information” filed on Oct. 19, 2021 and U.S. Provisional Application No. 63/271,254, entitled “Additional NW scheduling availability for SMTC window or measurement gap and potential UE assistance information with VR mode indication”, filed on Oct. 25, 2021, the subject matter of which is incorporated herein by reference.

### TECHNICAL FIELD

The disclosed embodiments relate generally to wireless communication, and, more particularly, to data scheduling within some specific time duration.

### BACKGROUND

The wireless communications network has grown exponentially over the years. A long-term evolution (LTE) system offers high peak data rates, low latency, improved system capacity, and low operating cost resulting from simplified network architecture. LTE systems, also known as the 4G system, also provide seamless integration to older wireless network, such as GSM, CDMA and universal mobile telecommunication system (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. The next generation mobile network (NGMN) board, has decided to focus the future NGMN activities on defining the end-to-end requirements for 5G new radio (NR) systems.

In conventional communication technology, the UE may be configured a measurement gap for neighbor cell measurement. That is to say, in the measurement gap, the network node may not configure UE to transmit or receive data. However, for some real-time application (e.g., virtual reality (VR) or augmented reality (AR)) performing on the serving cell, the service may be affected when the UE needs to perform neighbor cell measurement on the configured measurement gap. The user experience will be affected.

Therefore, how to maintain the service quality and reduce data interruption of the real-time application is worthy of discussion.

### SUMMARY

Apparatus and method for data scheduling are proposed. The user equipment (UE) may determine an indication or a measurement report to the network node according to an enabling condition or a disabling condition for determining whether to schedule data within at least one time duration which is configured to the UE for measurement. The UE may transmit the indication or the measurement report to the network node. Based on the indication or the measurement report, the network node may determine whether to schedule data within the at least one time duration which is configured to the UE for measurement. Therefore, for some real-time application (e.g., virtual reality (VR) or augmented reality (AR)), the service will not be interrupted.

In one embodiment, a network node schedules data within at least one time duration in an event that a quality of a serving cell is larger than a first threshold for a first number of times, wherein the at least one time duration is configured to a user equipment (UE) for measurement. Then, the network node directly receives or transmits data from or to the UE within the at least one time duration, or transmits a network indication to the UE to indicate the UE to transmit or receive data within the at least one time duration.

In one embodiment, a user equipment (UE) transmits an indication or a measurement report to a network node according to an enabling condition for determining whether to schedule data within at least one time duration, wherein the at least one time duration is configured to the UE for measurement. Then, the UE performs data reception or data transmission within the at least one time duration.

In another embodiment, a network node receives an indication or a measurement report from a user equipment (UE) to determine whether to schedule data within at least one time duration, wherein the at least one time duration is configured to the UE for the measurements. Then, the network node schedules the data within the at least one time duration in an event that the indication or the measurement report is associated with an enabling condition.

In another embodiment, a network node receives an assistant information from a user equipment (UE), wherein the assistant information indicates a current operation mode of the UE. Then, the network node determines whether to schedule data within at least one time duration based on the current operation mode, wherein the at least one time duration is configured to the UE for the measurements.

Other embodiments and advantages are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 is a simplified block diagram of a network node and a user equipment that carry out certain embodiments of the present invention.

FIG. 2 illustrates a procedure for scheduling data in accordance with one novel aspect.

FIG. 3 illustrates a procedure for scheduling data in accordance with another novel aspect.

FIG. 4 illustrates a procedure for scheduling data in accordance with another novel aspect.

FIG. 5 is a flow chart of method for scheduling data in accordance with one novel aspect.

FIG. 6 is a flow chart of method for scheduling data in accordance with another novel aspect.

FIG. 7 is a flow chart of method for scheduling data in accordance with another novel aspect.

FIG. 8 is a flow chart of method for scheduling data in accordance with another novel aspect.

FIG. 9 is a flow chart of method for scheduling data in accordance with another novel aspect.

### DETAILED DESCRIPTION

Reference will now be made in detail to some embodiments of the invention, examples of which are illustrated in the accompanying drawings.

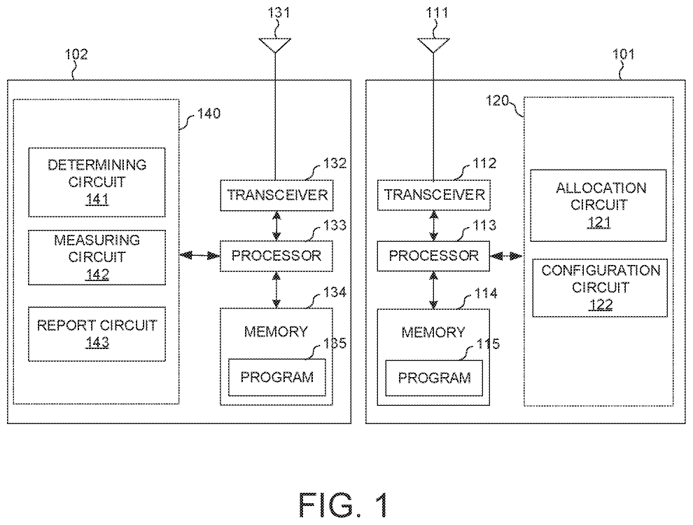

FIG. 1 is a simplified block diagram of a network node and a user equipment (UE) that carry out certain embodiments of the present invention. The network node 101 may be a base station (BS) or a gNB, but the present invention should not be limited thereto. The UE 102 may be a smart phone, a wearable device, an Internet of Things (IoT) device, and a tablet, etc. Alternatively, UE 102 may be a Notebook (NB) or Personal Computer (PC) inserted or installed with a data card which includes a modem and RF transceiver(s) to provide the functionality of wireless communication.

Network node 101 has an antenna array 111 having multiple antenna elements that transmits and receives radio signals, one or more RF transceiver modules 112, coupled with the antenna array 111, receives RF signals from antenna array 111, converts them to baseband signal, and sends them to processor 113. RF transceiver 112 also converts received baseband signals from processor 113, converts them to RF signals, and sends out to antenna array 111. Processor 113 processes the received baseband signals and invokes different functional modules and circuits 120 to perform features in network node 101. Memory 114 stores program instructions and data 115 to control the operations of network node 101. Network node 101 also includes multiple function modules that carry out different tasks in accordance with embodiments of the current invention.

Similarly, UE 102 has an antenna array 131, which transmits and receives radio signals. A RF transceiver 132, coupled with the antenna, receives RF signals from antenna array 131, converts them to baseband signals and sends them to processor 133. RF transceiver 132 also converts received baseband signals from processor 133, converts them to RF signals, and sends out to antenna array 131. Processor 133 processes the received baseband signals and invokes different functional modules and circuits 140 to perform features in UE 102. Memory 134 stores program instructions and data 135 to control the operations of UE 102. UE 102 also includes multiple function modules and circuits that carry out different tasks in accordance with embodiments of the current invention.

The functional modules and circuits 120 and 140 can be implemented and configured by hardware, firmware, software, and any combination thereof. The function modules and circuits 120 and 140, when executed by the processors 113 and 133 (e.g., via executing program codes 115 and 135), allow network node 101 and UE 102 to perform embodiments of the present invention.

In the example of FIG. 1, the network node 101 may comprise an allocation circuit 121 and a report circuit 122. Allocation circuit 121 may configure the s-MeasureConfig which indicates the threshold for special cell (SpCell) reference symbol received power (RSRP) measurement. In addition, allocation circuit 121 may determine whether to schedule data based on the indication or measurement report from the UE 102. Configuration circuit 122 may transmit the s-Measure Config and the scheduled data to the UE 102.

In the example of FIG. 1, the UE 102 may comprise a determining circuit 141, a measuring circuit 142 and a report circuit 143. Determining circuit 141 may determine an indication or a measurement report for the network node 101 determining whether to schedule data within at least one time duration which is configured to the UE 102 for the measurements. Measuring circuit 142 may measure the quality of the serving cell. Report circuit 143 may transmit the indication or the measurement report to the network node 101.

In accordance with one novel aspect, the UE 102 may transmit an indication or a measurement report to the network node 101. Then, the network node 101 may determine whether to schedule data within at least one time duration based on the indication or the measurement report. In addition, the UE 102 may not perform measurement within the time duration. Based on the indication or the measurement report from the UE 102, the network node 101 may know whether the UE 102 performs measurement or not within the time duration. On the other hand, the network node 101 may also determine whether disable to the scheduling of the data within the time duration based on the indication or the measurement report.

In the embodiments of the invention, the time duration may be originally configured to the UE 102 for measurement by the network 101. In an example, the time duration may comprise at least one of a measurement gap for neighbor cell measurement, a scheduling availability during a synchronization signal block-based radio resource management (RRM) measurement timing configuration (SMTC) window, and the SMTC window. In an example, the scheduling availability may be the scheduling availability of the UE performing measurements with a different subcarrier spacing than physical downlink control channel (PDCCH) or physical downlink shared channel (PDSCH) on frequency range 1 (FR1). In another example, the scheduling availability may be the scheduling availability of the UE performing measurements on frequency range 2 (FR2).

In addition, in another example, the time duration may comprise at least one of a measurement gap for a radio link monitoring, a measurement gap for a beam failure detection, a measurement gap for a layer 1 (L1)-reference symbol received power (RSRP) measurement and a measurement gap for a candidate beam detection.

In accordance with one novel aspect, an application delay within the time duration may be predefined or determined based on the reported capability of the UE 102.

In accordance with one novel aspect, the UE 102 may transmit the indication through an uplink (UL) medium access control-control element (MAC-CE), a PUCCH, an uplink control information (UCI) or a radio resource control (RRC) signaling.

In accordance with one novel aspect, the UE 102 may transmit an indication or a measurement report to the network node 101 according to an enabling condition or a disabling condition.

In accordance with one novel aspect, the enabling condition may comprise that the UE 102 is configured with a s-MeasureConfig by the network node 101 and a reference symbol received power (RSRP) value of a serving cell is larger than a threshold for a period of time. When the enabling condition is met, the UE 102 may transmit the indication to the network node 101 based on the enabling condition to inform that the network node 101 is able to schedule data within at least one time duration. In the embodiment, the s-MeasureConfig may indicate the threshold. In addition, in the embodiment, the disabling condition may comprise that when the UE 102 is configured with the s-Measure Config by the network node 101 and the RSRP value of the serving cell is not larger than the threshold indicated by the s-MeasureConfig for a period of time. When the disabling condition is met, the UE 102 may transmit the indication to the network node 101 to inform the network node 101 based on the disabling condition to inform that the network node 101 is able to disable the scheduling of data within the time duration. In the embodiment, the network node 101 may determine whether schedule data within the time duration based on the indication from the UE 102.

In accordance with another novel aspect, the enabling condition may comprise that when a quality of a serving cell is larger than a threshold for a period of time. When the enabling condition is met, the UE 102 may transmit the indication to the network node 101 based on the enabling condition to inform that the network node 101 is able to schedule data within at least one time duration. In the embodiment, the quality of the serving cell may comprise at least one of a channel quality indicator (CQI), a L1-RSRP, a L1-signal to interference-plus-noise ratio (SINR), SINR to estimate hypothetical block error rate (BLER), synchronization signal (SS)-RSRP, SS-reference signal received quality (RSRQ), and SS-SINR. In addition, in the embodiment, the disabling condition may comprise that when the quality of the serving cell is not larger than the threshold for a period of time. When the disabling condition is met, the UE 102 may transmit the indication based on the disabling condition to the network node 101 to inform that the network node 101 is able to disable the scheduling of data within the time duration. In the embodiment, the threshold may be configured by the network node 101 or pre-defined. In the embodiment, the network node 101 may determine whether schedule data within the time duration based on the indication from the UE 102.

In accordance with another novel aspect, when one of the following enabling conditions is met, the UE 102 may transmit the indication to the network node 101 to inform that the network node 101 is able to schedule data within at least one time duration. In an example, the enabling condition may comprise that an updating of the UE receiving (RX) beam is not needed. In another example, the enabling condition may comprise that a transmission configuration indication (TCI) of physical downlink control channel (PDCCH) or physical downlink shared channel (PDSCH) is unchanged for a period of time. In another example, the enabling condition may comprise that the number of changing the TCI of PDCCH or PDSCH is less than a threshold (e.g., less than the default number of times) during a period of time. In addition, in the embodiment, when one of the following disabling conditions is met, the UE 102 may transmit the indication to the network node 101 to inform the network node 101 to disable the scheduling of data within the time duration indicated in the indication. In an example, the disabling condition may comprise that an updating of the UE RX beam is needed. In another example, the disabling condition may comprise that a TCI of PDCCH or PDSCH is changed for a period of time. In another example, the disabling condition may comprise that the number of changing the TCI of PDCCH or PDSCH is greater than a threshold (e.g., greater than the default number of times) during a period of time.

In accordance with one novel aspect, the UE 102 may transmit the measurement report for a quality of a serving cell periodically to the network node 101. The network node 102 may determine whether to schedule data within at least one time duration based on the measurement report for a quality of a serving cell from the UE 102. That is to say, in the embodiment, the UE 102 may not need to provide additional information to inform that the network node 101 is able to or not able to schedule data within at least one time duration. When the reported quality of the serving cell is larger than a first threshold for the first default number of times, the network node 101 may determine to schedule data within at least one time duration. That is to say, based on the quality of the serving cell, the network node 101 can determine whether to schedule the data within the time duration and know that the UE does not perform measurements within the time duration. In the embodiment, the quality of the serving cell may comprise at least one of a CQI, a L1-RSRP, a L1-SINR, SINR to estimate hypothetical BLER, SS-RSRP, SS-RSRQ, and SS-SINR. In addition, in the embodiment, when the quality of the serving cell is not larger than a second threshold for the second default number of times, the network node 101 may determine to disable the scheduling of the data within the time duration. In the embodiment, the threshold (e.g., the first threshold and the second threshold) and the default number of times (e.g. the first default number of times and the second default number of times) may be configured by the network node 101 or pre-defined. In the embodiment, the network node 101 may directly receive or transmit data from or to the UE 102 within the at least one time duration or the network node 101 may transmit a network indication to the UE 102 to indicate the UE 102 to transmit or receive data within the at least one time duration.

In accordance with a novel aspect, after the UE 102 transmits the indication or the measurement report to the network node 101 to inform that the network node 101 is able to schedule data within at least one time duration, the UE 102 may automatically perform data reception or data transmission within the time duration.

In accordance with another novel aspect, after the UE 102 transmits the indication or the measurement report to the network node 101 to inform that the network node 101 is able to schedule data within at least one time duration, the network node 101 may transmit an indication to the UE 102 to inform that the UE 102 is able to perform data reception or data transmission within the time duration.

In accordance with a novel aspect, the UE 102 may transmit an assistant information to the network node 101. The assistant information may indicate a current operation mode of the UE 102. The network node 101 may determine whether to schedule data within at least one time duration which is configured to the UE for measurement based on the assistant information. When the current operation mode of the UE 102 is a virtual reality (VR) mode (or other real-time application mode, e.g., augmented reality (AR) mode or clouding mode), the network node 101 may know that the network node 101 may determine to schedule the data within at least one time duration. In addition, when the current operation mode of the UE 102 is a virtual reality (VR) mode (or other real-time application mode e.g., augmented reality (AR) mode or clouding mode), the UE 102 may perform data reception or data transmission within the time duration. In addition, when the current operation mode of the UE 102 is not the VR mode (or other real-time application mode e.g., AR mode or clouding mode), the network node 101 may determine to disable the scheduling of the data within at least one time duration and the UE 102 may resume normal measurement behavior within the time duration.

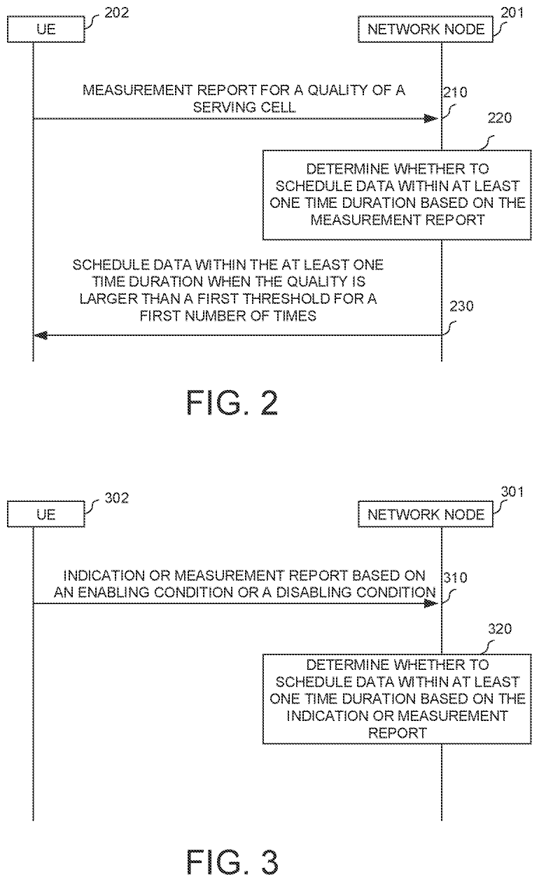

FIG. 2 illustrates a procedure for scheduling data in accordance with one novel aspect. In step 210, the UE 202 may transmit a measurement report for a quality of a serving cell to the network node 201.

In step 220, the network node 201 may determine whether to schedule the data within at least one time duration based on the measurement report, wherein the at least one time duration is configured to the UE 202 for measurement.

In step 230, when the quality of the serving cell is larger than a first threshold for a first number of times, the network node 201 may determine to schedule data within at least one time duration. Then, in an example, the network node 201 may directly receive or transmit data from or to the UE 202 within the at least one time duration, i.e., the network node 201 may automatically enable the transmission and the reception with the UE 202. In another example, the network node 201 may transmit a network indication to the UE 202 to indicate the UE 102 to transmit or receive data within the at least one time duration. In addition, when the quality of the serving cell is smaller than or equal to a second threshold for a second number of times, the network node 201 may determine to disable the scheduling of data within at least one time duration.

FIG. 3 illustrates a procedure for scheduling data in accordance with another novel aspect. In step 310, the UE 302 may transmit an indication or a measurement report to the network node 301 based on an enabling condition or a disabling condition.

In step 320, the network node 301 may determine whether to schedule data within the at least one time duration to the UE 301 based on the indication or the measurement report, wherein the at least one time duration is configured to the UE 302 for measurement. When the indication or the measurement report is associated with the enabling condition, the network node 301 may determine to schedule data within the at least one time duration to the UE 301. In addition, when the indication or the measurement report is associated with the disabling condition, the network node 301 may determine to disable the scheduling of data within the at least one time duration to the UE 301.

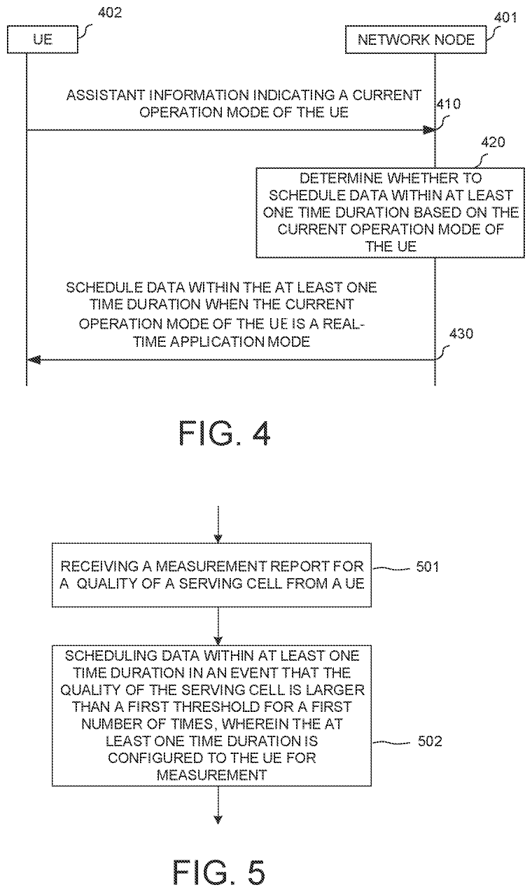

FIG. 4 illustrates a procedure for scheduling data in accordance with another novel aspect. In step 410, the UE 401 may transmit an assistant information to the network node 401, wherein the assistant information indicates a current operation mode of the UE 402.

In step 420, the network node 401 may determine whether to schedule data within at least one time duration based on the current operation mode of the UE 402, wherein the at least one time duration is configured to the UE 402 for measurement.

In step 430, when the current operation mode of the UE 402 is a virtual reality (VR) mode (or a real-time application mode), the network node 401 may determine to schedule data within at least one time duration. In addition, when the current operation mode of the UE 402 is not a virtual reality (VR) mode (or a real-time application mode), the network node 401 may determine to disable the scheduling of data within at least one time duration.

FIG. 5 is a flow chart of method for scheduling data in accordance with one novel aspect. In step 501, the network node 101 receives a measurement report for a quality of a serving cell from the UE 102.

In step 502, the network node 101 may determine to schedule data within at least one time duration in an event that the quality of the serving cell is larger than a first threshold for a first number of times, wherein the at least one time duration is configured to the UE 102 for measurement. Then, in an example, the network node 101 may directly receive or transmit data from or to the UE 102 within the at least one time duration, i.e., the network node 101 may automatically enable the transmission and the reception with the UE 102. In another example, the network node 101 may transmit a network indication to the UE 102 to indicate the UE 102 to transmit or receive data within the at least one time duration.

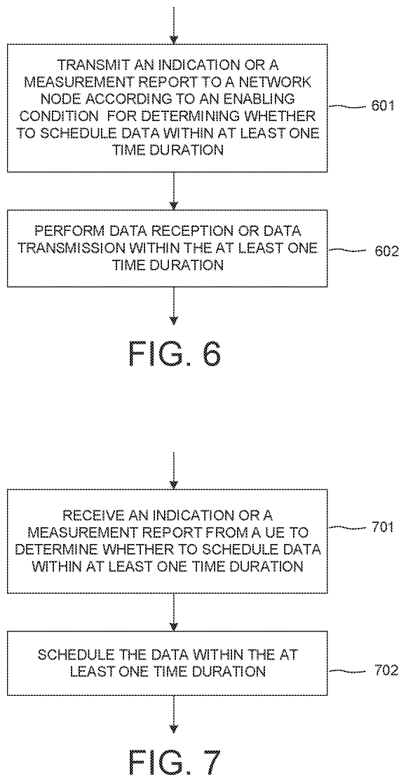

FIG. 6 is a flow chart of method for scheduling data in accordance with another novel aspect. In step 601, the UE 102 may transmit an indication or a measurement report to the network node 101 according to an enabling condition for determining whether to schedule data within at least one time duration, wherein the at least one time duration is configured to the UE 102 for measurement.

In step 602, the UE 102 may perform data reception or data transmission within the at least one time duration.

FIG. 7 is a flow chart of method for scheduling data in accordance with another novel aspect. In step 701, the network node 101 may receive an indication or a measurement report from the UE 102 to determine whether to schedule data within at least one time duration, wherein the at least one time duration is configured to the UE 102 for the measurements.

In step 702, the network node 101 may determine to schedule data within the at least one time duration when the indication or the measurement report is associated with an enabling condition.

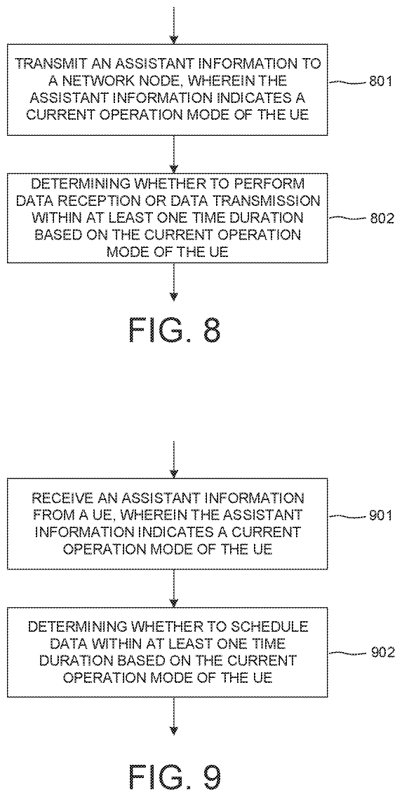

FIG. 8 is a flow chart of method for scheduling data in accordance with another novel aspect. In step 801, the UE 102 may transmit an assistant information to the network node 101, wherein the assistant information indicates a current operation mode of the UE 102.

In step 802, the UE 102 may determine whether to perform data reception or data transmission within at least one time duration based on the current operation mode of the UE 102, wherein the at least one time duration is configured to the UE 102 for the measurements.

In the method, when the current operation mode of the UE 102 is a virtual reality (VR) mode (or a real-time application mode), the UE 102 may perform data reception or data transmission within at least one time duration.

FIG. 9 is a flow chart of method for scheduling data in accordance with another novel aspect. In step 901, the network node 101 may receive an assistant information from the UE 102, wherein the assistant information indicates a current operation mode of the UE 102.

In step 902, the network node 101 may determine whether to schedule data within at least one time duration based on the current operation mode of the UE 102, wherein the at least one time duration is configured to the UE 102 for the measurements.

In the method, when the current operation mode of the UE 102 is a virtual reality (VR) mode (or a real-time application mode), the network node 101 may determine to schedule data within at least one time duration. In addition, when the current operation mode of the UE 102 is not a virtual reality (VR) mode (or a real-time application mode), the network node 101 may determine to disable the scheduling of data within at least one time duration.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
directly receiving or transmitting, by the network node, data from or to a user equipment (UE) within the at least one time duration; or
transmitting, by the network node, a network indication to the UE to indicate the UE to transmit or receive data within the at least one time duration,
wherein the at least one time duration is configured to the UE for measurement.

2. The method of claim 1, wherein the at least one time duration comprises at least one of a measurement gap for neighbor cell measurement, a scheduling availability during a synchronization signal block-based radio resource management (RRM) measurement timing configuration (SMTC) window and the SMTC window.

3. The method of claim 1, further comprising:
receiving, by the network node, a measurement report for the quality of the serving cell from the UE, wherein the network indication is based on an event that a quality of a serving cell is larger than a first threshold for a first number of times.

4. The method of claim 1, further comprising:
disabling, by the network node, the scheduling of data within the at least one time duration.

5. A method, comprising:
transmitting, by a user equipment (UE), an indication or a measurement report to a network node according to an enabling condition for determining whether to schedule data within at least one time duration, wherein the at least one time duration is configured to the UE for measurement; and
performing, by the UE, data reception or data transmission within the at least one time duration.

6. The method of claim 5, wherein the at least one time duration comprises at least one of a measurement gap for neighbor cell measurement, a scheduling availability during a synchronization signal block-based radio resource management (RRM) measurement timing configuration (SMTC) window and the SMTC window, or the at least one time duration comprises a measurement gap for at least one of a radio link monitoring, a beam failure detection, a layer 1 (L1)-reference symbol received power (RSRP) measurement and a candidate beam detection.

7. The method of claim 5, wherein the enabling condition comprises that the UE is configured with a s-MeasureConfig by the network node and a reference symbol received power (RSRP) value of a serving cell is larger than a threshold for a period of time, and wherein the s-MeasureConfig indicates the threshold.

8. The method of claim 5, wherein the enabling condition comprises that a quality of a serving cell is larger than a threshold for a period of time.

9. The method of claim 5, wherein the enabling condition comprises that an updating of a UE receiving (RX) beam is not needed, a transmission configuration indication (TCI) of physical downlink control channel (PDCCH) or physical downlink shared channel (PDSCH) is unchanged for a period of time, or a number of changing the TCI of PDCCH or PDSCH is less than a threshold during a period of time.

10. The method of claim 5, wherein the indication is transmitted through an uplink (UL) medium access control-control element (MAC-CE), a PUCCH, an uplink control information (UCI) or a radio resource control (RRC) signaling.

11. The method of claim 5, further comprising:
automatically determining, by the UE, to transmit or receive data within the at least one time duration; or
determining, by the UE, to transmit or receive data within the at least one time duration according to a network indication from the network node.

12. The method of claim 5, further comprising:
transmitting, by the UE, the indication or the measurement report to the network node to disable the scheduling of data within the at least one time duration.

13. The method of claim 12, wherein the disabling is based on an event that the quality of the serving cell is smaller than or equal to a second threshold for a second number of times.

14. A method, comprising:
receiving, by a network node, an indication or a measurement report from a user equipment (UE) to determine whether to schedule data within at least one time duration, wherein the at least one time duration is configured to the UE for measurement; and
scheduling the data, by the network node, within the at least one time duration.

15. The method of claim 14, wherein the at least one time duration comprises at least one of a measurement gap for neighbor cell measurement, a scheduling availability during a synchronization signal block-based radio resource management (RRM) measurement timing configuration (SMTC) window and the SMTC window, or the at least one time duration comprises a measurement gap for at least one of a radio link monitoring, a beam failure detection, a layer 1 (L1)-reference symbol received power (RSRP) measurement and a candidate beam detection.

16. The method of claim 14, wherein the indication is received in an event that the UE is configured with a s-MeasureConfig by the network node and a reference symbol received power (RSRP) value of a serving cell is larger than a threshold for a period of time, wherein the s-MeasureConfig indicates the threshold.

17. The method of claim 14, wherein the indication is received in an event that a quality of a serving cell is larger than a threshold for a period of time.

18. The method of claim 14, wherein the indication is received in an event that an updating UE receiving (RX) beam is not needed, a transmission configuration indication (TCI) of physical downlink control channel (PDCCH) or physical downlink shared channel (PDSCH) is unchanged for a period of time, or a number of changing the TCI of PDCCH or PDSCH is less than a threshold during a period of time.

19. The method of claim 14, further comprising:
receiving, by the network node, the indication or the measurement report from the UE to determine whether to disable scheduling of data within the at least one time duration.

20. A method, comprising:
receiving, by a network node, an assistant information from a user equipment (UE), wherein the assistant information indicates a current operation mode of the UE; and
determining, by the network node, whether to schedule data within at least one time duration based on the current operation mode, wherein the at least one time duration is configured to the UE for measurement.

21. The method of claim 20, wherein the at least one time duration comprises at least one of a measurement gap for neighbor cell measurement, a scheduling availability during a synchronization signal block-based radio resource management (RRM) measurement timing configuration (SMTC) window and the SMTC window.
